(19) United States
(12) Patent Application Publication
(10) Pub. No.: US 2004/0212679 A1
(43) Pub. Date: Oct. 28, 2004

(54) Computer-based remote surveillance cctv system, a computer video matrix switcher and a control program adapted to the cctv system

(76) Inventor: Ho-Jin Jun, Seoul (KR)

Correspondence Address: Peter T Kwon, Kangnam P O Box 2301, Seoul, 135-242, KR

(21) Appl. No.: 10/250,949

(22) PCT Filed: Dec. 17, 2001
(86) PCT No.: PCT/KR01/02186

(30) Foreign Application Priority Data
Jan. 9, 2001 (KR) 2001/1079

(51) Int. Cl. H04N 5/232

(52) U.S. Cl. 348/159

(57) ABSTRACT

Disclosed are a closed circuit television (CCTV) system controlled by a control program installed in a remote surveillance computer, and a matrix switcher used for the CCTV system. The computer-based remote surveillance CCTV system is comprised of a computer video matrix switcher for processing an image signal from a camera and transmitting the processed signal to a video input terminal of the surveillance computer; and a control program, installed in the surveillance computer, for controlling the operation of the computer video matrix switcher and creating camera control data.

### TECHNICAL FIELD

The present invention relates to a closed circuit television surveillance system which controls remote surveillance by a control program module installed in a personal computer, and to a matrix switcher which is used for the system.

### BACKGROUND ART

A conventional closed circuit television (CCTV) system to remotely monitor a plurality of cameras receives video signals from the cameras using a video matrix switcher and outputs videos on a normal analog CCTV monitor. In such a conventional system, a matrix control board (keyboard) additionally connected so as to control the cameras is connected to the video matrix switcher to control the cameras, and video signals from the cameras are received through an additional video line and monitored using the monitor.

FIG. 1 is a block diagram of a conventional CCTV system using a typical video matrix switcher. Video signals are inputted to the matrix switcher arranged in the center portion of the CCTV system from a plurality of cameras CA-1 to CA-n. The matrix switcher is connected to a monitor of a main management office, monitors at remote places and a control keyboard. In FIG. 1, signal lines indicated with solid lines are video signal lines, while the signal lines indicated with dashed lines are data lines used to control cameras.

However, as shown in FIG. 1, the conventional CCTV system is problematic in that since it must additionally memorize the identifications (IDs) of multiple cameras installed at respective locations, and displays a screen and controls cameras by selecting a desired camera using an additionally installed keyboard, the control function and control device of the CCTV system are complicated. Further, the conventional CCTV system is problematic in that it is also difficult for a user to search for screens later because it is difficult to execute data processing and storing of screens according to cameras.

### DISCLOSURE OF THE INVENTION

Accordingly, in order to solve the above problems occurring in the prior art, the inventor of the present invention has designed a computer video matrix switcher and CCTV system using the same, which can be controlled by a control program module installed in a computer. An object of the present invention is to provide a CCTV system and computer video matrix switcher used for the CCTV system, in which a control program module is installed in a computer to control cameras and display videos using the control program module, such that a management office can easily monitor and control videos of cameras by only using the program of the personal computer (PC), and which can arbitrarily select and monitor videos of cameras on a monitor of the computer without additionally memorizing and recording information.

According to the present invention, displaying moving pictures and controlling various functions can be easily performed on a computer monitor using a computer by a graphic user interface (GUI) menu so as to easily and promptly perform monitoring and controlling operations even in monitoring areas which are widely distributed.

A CCTV system of the present invention comprises a computer video matrix switcher for processing inputted camera video signals and transmitting processed video signals to a video input terminal of a surveillance computer; and a control program module installed in the surveillance computer (hereinafter, referred to as a computer) for allowing the computer video matrix switcher to perform tasks, and generating data (hereinafter, referred to as camera control data) for driving and controlling cameras.

The computer video matrix switcher which is an important part of the system includes a central processing unit (CPU); a communication control unit for performing data exchange with the computer in which the control program module is installed to receive operation commands for the CPU and the camera control data from the computer and to transmit performance results to the computer; a video signal input unit for inputting camera video signals transmitted from a plurality of cameras through coaxial cables; a video input signal switching unit for selecting inputted camera video signals under the control of the CPU; and a composite signal output unit for converting video input signals into composite signals to be displayed on a monitor of the computer, and outputting the composite signals to the video input terminal of the computer.

The control program module of the system includes a control data generation unit for generating commands for controlling the CPU of the computer video matrix switcher and the camera control data; a camera focus adjustment unit for allowing the user to focus the camera; a camera focus control unit for controlling the control data generation unit through the camera focus adjustment unit to generate data for controlling the focus of each camera; a camera zoom selection unit comprised of a camera zoom in button (+) and a camera zoom out button (−) for allowing the user to select a camera zoom function; a camera zoom control unit for controlling the control data generation unit through the camera zoom selection unit to generate data for controlling the zoom of the camera; a camera panning selection unit comprised of buttons for indicating panning directions of each camera and buttons for adjusting panning speeds to allow the user to select a panning function of each camera and adjust a panning speed of each camera; a camera panning control unit for controlling the control data generation unit through the camera panning selection unit to generate data for controlling the panning of each camera and adjusting the panning speed of each camera; a camera automatic panning selection unit comprised of a pan start point setting button, a pan return point setting button, an automatic pan start button and an automatic pan stop button to allow the user to set an automatic panning function of each camera; a camera automatic panning control unit to control the control data generation unit through the camera automatic panning selection unit to generate data for automatic panning of each camera; a camera automatic switchover setting unit comprised of a setting button for setting cameras to be automatically switched over or setting a switchover time, and a start button for activating automatic switchover to allow the user to set a automatic switchover function of each camera; a camera automatic switchover control unit for controlling the control data generation unit through the camera automatic switchover setting unit to generate data for automatic switchover of each camera; an adjustment/selection/setting data storage unit for storing data adjusted, selected and set by the camera focus adjustment unit, the camera zoom selection unit, the camera panning selection unit, the camera automatic panning selection unit and the camera automatic switchover setting unit; a camera position memorizing unit for memorizing positions of all cameras installed in various locations; and a video display unit for displaying video signals received from the computer video matrix switcher through a predetermined user interface.

### BRIEF DESCRIPTION OF THE DRAWINGS

FIG. 1 is a block diagram of a conventional CCTV system;

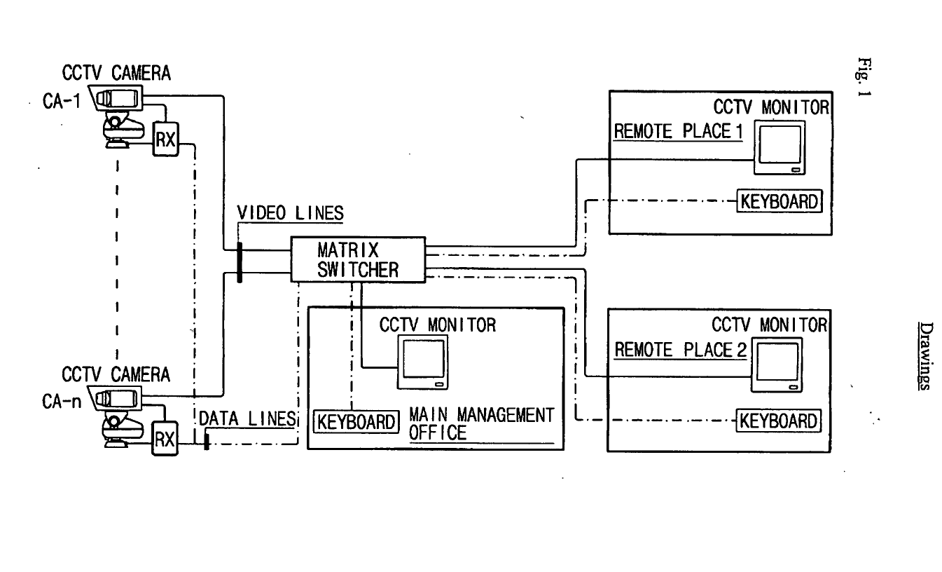

FIG. 2 is a block diagram of a CCTV system according to the present invention;

FIG. 3 is a block diagram of a computer video matrix switcher used in the present invention;

FIG. 4A is functional diagram of a control program module used in the present invention;

FIG. 4B is a functional diagram of an extended control program module used in the present invention; and

FIG. 5 is a view showing a user interface screen of the control program module.

### BEST MODE FOR CARRYING OUT THE INVENTION

Hereinafter, the preferred embodiment of a system according to the present invention is described in detail.

### Construction of System

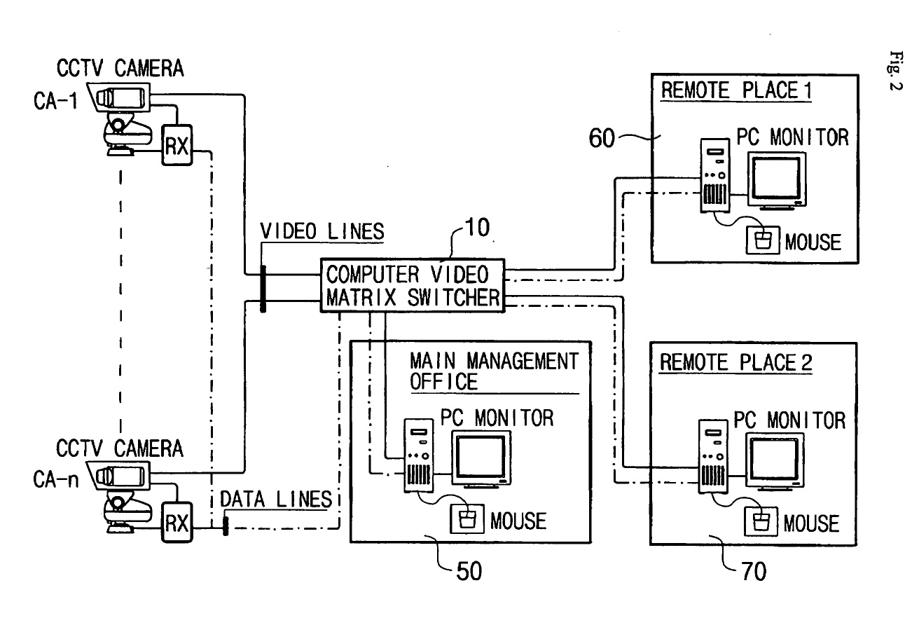

FIG. 2 is a block diagram of a CCTV system using a computer video matrix switcher (hereinafter, referred to as a matrix switcher of the present invention) according to the present invention.

Video signals received from a plurality of CCTV cameras CA-1 to CA-n are inputted to a matrix switcher 10 of the present invention. Referring to FIG. 2, the solid lines are video signal lines, while dashed lines are data lines to control cameras. Further, the matrix switcher 10 of the present invention is connected to a PC of a main management office 50, and PCs at remote places 60 and 70.

The matrix switcher 10 processes inputted camera video signals, and transmits the processed camera video signals to a video input terminal of each of the PCs of the main management office 50 and the remote places 60 and 70. Each PC has a control program module installed therein to control the matrix switcher 10 of the present invention and allow a user to perform a monitoring function.

Users of the main management office and the remote places can select and monitor each CCTV camera and perform various camera control functions by manipulating menu buttons on the screen while watching videos photographed by cameras through a GUI screen on a monitor of each PC in which the control program module is installed. Recently, since the GUI programs are generalized, it is possible to easily perform the monitoring and camera control functions by simply using a mouse, etc. on the screen displayed on a monitor.

### Construction of Computer Video Matrix Switcher

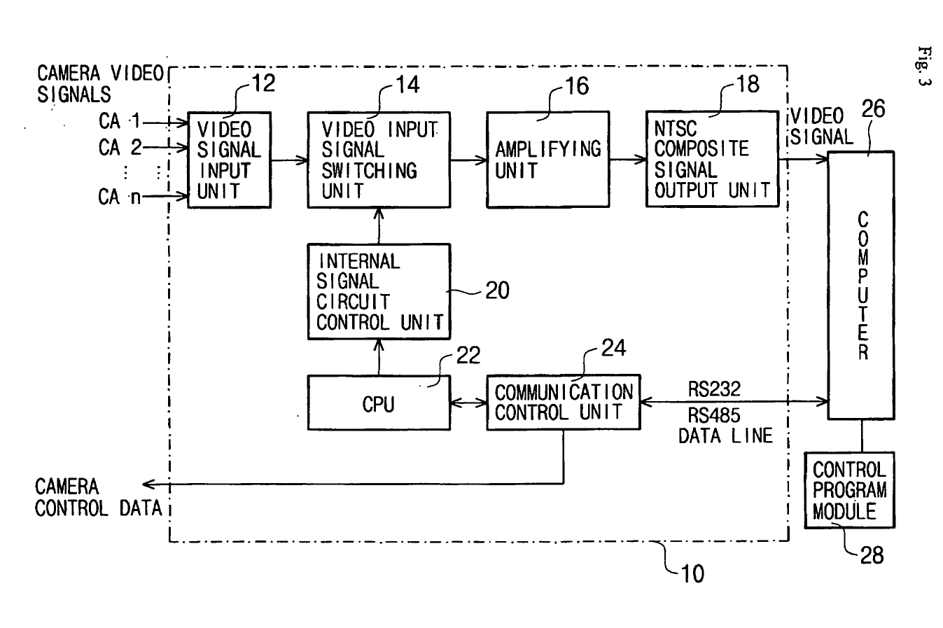

FIG. 3 is a block diagram showing an internal construction of the matrix switcher 10 of the present invention. As shown in FIG. 3, camera video signals CA1 to CAn are inputted to the matrix switcher 10 and processed. The processed video signals are transmitted to the video input terminal of a PC 26 (hereinafter, referred to as a computer) of the main management office and remote places. The matrix switcher 10 performs tasks by a control program module 28 installed in the computer 26. Data for driving and controlling cameras (camera control data) are also generated by the control program module 28 of the computer 26.

The matrix switcher 10 of the present invention includes:

a central processing unit (CPU) 22,

a communication control unit 24 to perform data exchange with the computer 26, in which the control program module 28 is installed, to receive operation commands for the CPU 22 and the camera control data from the computer 26 and transmit performance results to the computer 26,

an internal signal circuit control unit 20 to control a signal circuit in the matrix switcher in response to commands of the CPU 22,

a video signal input unit 12 to receive the camera video signals transmitted from a plurality of cameras through coaxial cables,

a video input signal switching unit 14 to select the received camera video signals under the control of the internal signal circuit control unit 20,

an amplifying unit 16 to amplify switched video input signals, and

a composite signal output unit 18 to convert the video input signals into national television system committee (NTSC) composite signals and to output the composite video signals to the video input terminal of the computer 26, so as to display the video input signals on the monitor of the computer 26.

In the above construction, the video output of the composite signal output unit 18 is inputted to the video input terminal of the computer 26 through coaxial cables. The communication control unit 24 and the computer 26 communicate with each other using a typical serial communication method such as RS232C and RS485.

The camera control data are data for functions such as pan, zoom and switchover of cameras, which can be set and selected by the user using the control program module 28. Further, the internal signal circuit control unit 20 can be functionally integrated with the CPU 22.

### Construction of Control Program Module

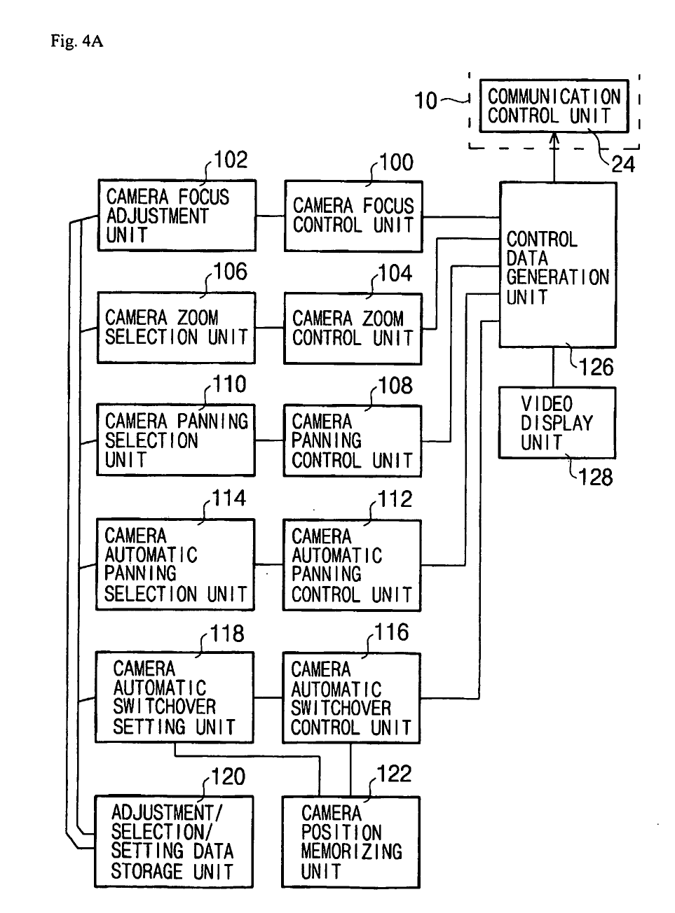

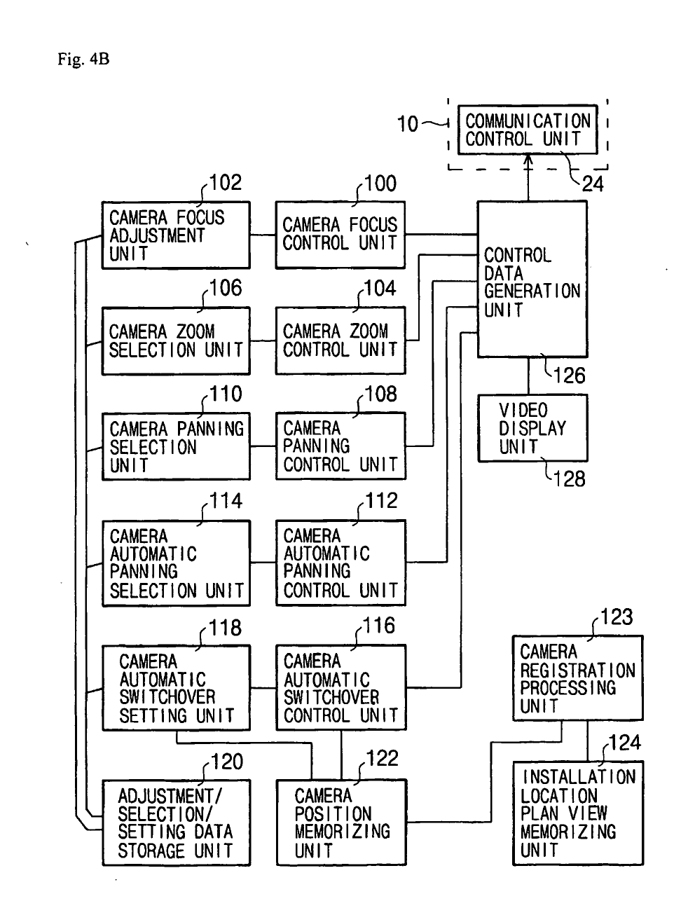

FIG. 4A is functional block diagram of the control program module 28 installed in the computer 26. The control program module 28 includes:

a control data generation unit 126 to generate commands for controlling the CPU 22 of the matrix switcher 10 and the camera control data,

a camera focus adjustment unit 102 to allow the user to focus each camera,

a camera focus control unit 100 to control the control data generation unit 126 through the camera focus adjustment unit 102 to generate data for controlling the focus of each camera,

a camera zoom selection unit 106 to allow the user to select a camera zoom function,

a camera zoom control unit 104 to control the control data generation unit 126 through the camera zoom selection unit 106 to generate data for controlling the zoom of each camera,

a camera panning selection unit 110 to allow the user to select a camera panning function and adjust a panning speed of each camera,

a camera panning control unit 108 to control the control data generation unit 126 through the camera panning selection unit 110 to generate data for controlling the panning of each camera and adjusting the panning speed thereof,

a camera automatic panning selection unit 114 to allow the user to set automatic panning of each camera,

a camera automatic panning control unit 112 to control the control data generation unit 126 through the camera automatic panning selection unit 114 to generate data for automatic panning of each camera,

a camera automatic switchover setting unit 118 to allow the user to set automatic switchover of each camera,

a camera automatic switchover control unit 116 to control the control data generation unit 126 through the camera automatic switchover setting unit 118 to generate data for automatic switchover of each camera,

an adjustment/selection/setting data storage unit 120 to store data adjusted, selected and set by the camera focus adjustment unit 102, the camera zoom selection unit 106, the camera panning selection unit 110, the camera automatic panning selection unit 114 and the camera automatic switchover setting unit 118,

a camera position memorizing unit 122 to memorize positions of all cameras installed in various locations, and

a video display unit 128 to display video signals received from the matrix switcher 10 through a predetermined user interface.

In the above construction, the camera automatic switchover control unit 116 executes data processing with reference to camera position data memorized in the camera position memorizing unit 122.

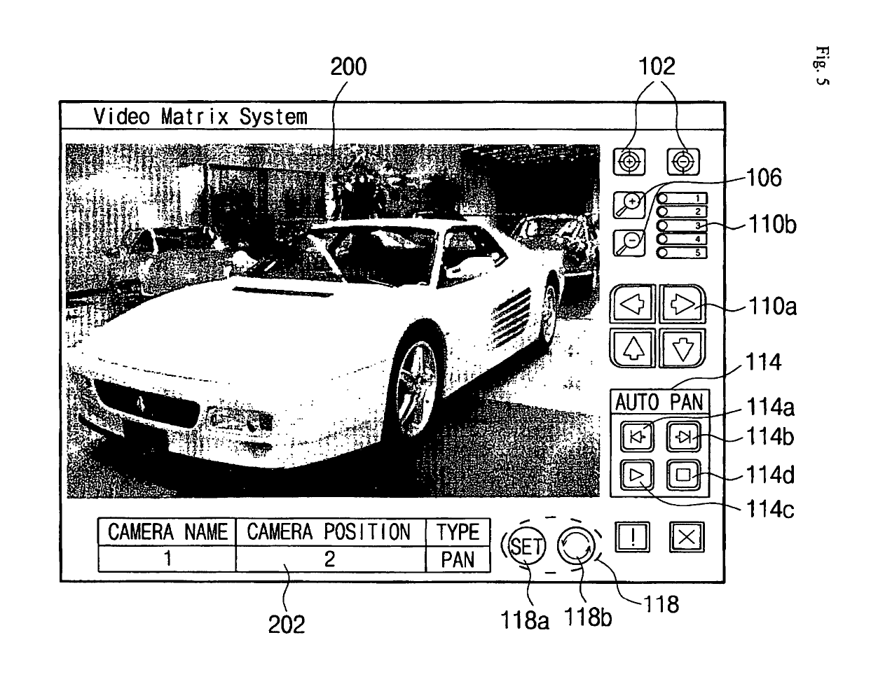

Meanwhile, FIG. 5 is a view showing an example of a user interface (UI) screen of the control program module having the above construction, wherein videos of presently monitoring a parking area are displayed on a video display window 200. In this case, a large screen moving picture display of 640×480 pixels is used as the video display window 200.

In the right portion of the screen, a radio button for adjusting the focus of each camera is arranged. This radio button indicates the camera focus adjustment unit 102. If the user adjusts the button of the camera focus adjustment unit 102, the control data generation unit 126 generates camera focus control data by the camera focus control unit 100, and transmits the camera focus control data to a corresponding camera through the matrix switcher 10 (refer to a path of camera control data in FIG. 3).

Referring back to FIG. 5, it can be seen that the camera zoom selection unit 106 is implemented with two buttons (+) and (−) in a right portion of the screen. If the user adjusts the buttons of the camera zoom selection unit 106 using a pointing device such as a mouse, the camera zoom control unit 104 enables the control data generation unit 126 to generate control data corresponding to the adjusted button, thus controlling the zoom of a corresponding camera.

The camera panning selection unit 110 is implemented with arrow buttons 110a such as [←], [→], [↑] and [↓] representing panning directions of a camera, and panning speed level buttons 110b such as [1], [2], [3], [4] and [5]. The panning speed level data set by the user are stored adjustment/selection/setting data storage unit 120. A step [1] is the lowest panning speed, while a step [5] is the highest panning speed. The panning speed level buttons can be designed such that a button corresponding to a panning speed presently set is lighted with a green color.

The camera automatic panning selection unit 114 is indicated with “AUTO PAN”, wherein a reference numeral 114a of the above arrow buttons is a pan start point setting button, 114b pan return point setting button, 114c AUTO PAN start button and 114d AUTO PAN stop button. If the user sets the pan start point and the pan return point using the buttons 114a and the 114b, the set data are stored in the adjustment/selection/setting data storage unit 120. Further, if the user manipulates the buttons 114c and 114d, each camera starts to pan and stops the pan, respectively. The setting values are memorized in the storage unit, such that they can be automatically restored to their original states even if the computer is rebooted or the computer is reset after the power has gone off.

The camera automatic switchover setting unit 118 serves to select a function for automatically switching over cameras installed in various locations at regular time interval. In this case, the camera automatic switchover setting unit 118 is implemented with a set button 118a and a start button 118b. The set button 118a can be programmed to register cameras to be automatically switched over or set a switchover time. The camera automatic switchover setting unit 118 refers to and uses the position data of cameras from the camera position memorizing unit 122. Further, in order to operate the camera automatic switchover control unit 116, the position data of cameras are referred to from the camera position memorizing unit 122.

Meanwhile, referring to FIG. 5, a window 202 for displaying the name, the position and the operating state (type) of a present camera is arranged under the video display unit 200. FIG. 5 shows that a present camera “1” is directed at a second floor.

The control program module having the above construction can be recorded in a record medium such as a compact disc-read only memory (CD-ROM) and a floppy disc (FD). The user can realize the present invention by purchasing the computer video matrix switcher constructed as FIG. 3 and a CD storing the control program module, installing the system of FIG. 2, and installing the control program module to the PC. FIG. 4A shows important parts of the control program module. Additional parts relating to installation, setting and other UI can be easily selected by those skilled in the field to correspond to the design of the control program module.

### Addable Parts

The construction of the FIG. 4A can be extended to that of FIG. 4B. In FIG. 4B, a camera registration processing unit 123 and an installation location plan view memorizing unit 124 are added to as additional parts. The camera registration processing unit 123 is a part for registering and processing the position of each camera on an installation location plan view memorized in the installation location plan view memorizing unit 124. The position of each camera, which is registered in the camera registration processing unit 123, is memorized in the camera position memorizing unit 122. Further, the installation location plan view memorizing unit 124 memorizes a camera map of an installation location such that the positions of installed cameras are displayed on a plan view of a location such as a monitored building.

The above two parts (the camera registration processing unit 123 and the installation location plan view memorizing unit 124) are added, such that the user can allow the CPU 22 of the matrix switcher 10 to control the video input signal switching unit 14 so as to select a video signal of a corresponding camera by displaying a camera map on the video display window 200 of FIG. 5 and clicking a position of a desired camera. In this way, the user can easily monitor videos sent from a corresponding camera on the video display window 200 by conveniently displaying a camera map on the UI screen on which videos are displayed and clicking a position of a desired camera.

### Industrial Applicability

According to the present invention, the present invention is advantageous in that users can monitor areas through the function of a computer without memorizing the positions and IDs of cameras, and can play recorded videos by only searching for files stored in a hard disc. Further, the present invention is usable to a narrow place because it can display several screens by automatically switching over a plurality of cameras on a single monitor. Ultimately, the present invention can be applied to a surveillance system using a computer to easily display videos and perform control operations (the user can perform entire control operations using a GUI menu of the computer).

Additionally, the present invention can immediately store screens of connected videos to search for the screens later, can easily manage data according to cameras, floors, etc. and can simultaneously monitor a screen at a specific position at respective remote places.

1. A computer-based remote surveillance CCTV system, comprising:
a computer video matrix switcher for processing inputted camera video signals and transmitting processed video signals to a video input terminal of a surveillance computer; and
a control program module installed in the surveillance computer (hereinafter, referred to as a computer) for allowing the computer video matrix switcher to perform tasks, and generating data (hereinafter, referred to as camera control data) for driving and controlling cameras.

2. The CCTV system according to claim 1, wherein the computer video matrix switcher includes:
a central processing unit (CPU);
a communication control unit for performing data exchange with the computer in which the control program module is installed to receive operation commands for the CPU and the camera control data from the computer and to transmit performance results to the computer;
a video signal input unit for inputting camera video signals transmitted from a plurality of cameras through coaxial cables;
a video input signal switching unit for selecting inputted camera video signals under the control of the CPU; and
a composite signal output unit for converting video input signals into composite signals to be displayed on a monitor of the computer, and outputting the composite signals to the video input terminal of the computer.

3. The CCTV system according to claim 1 or 2, wherein the control program module includes:
a control data generation unit for generating commands for controlling the CPU of the computer video matrix switcher and the camera control data;
a camera focus adjustment unit for allowing the user to focus the camera;
a camera focus control unit for controlling the control data generation unit through the camera focus adjustment unit to generate data for controlling the focus of each camera;
a camera zoom selection unit comprised of a camera zoom in button (+) and a camera zoom out button (−) for allowing the user to select a camera zoom function;
a camera zoom control unit for controlling the control data generation unit through the camera zoom selection unit to generate data for controlling the zoom of the camera;
a camera panning selection unit comprised of buttons for indicating panning directions of each camera and buttons for adjusting panning speeds to allow the user to select a panning function of each camera and adjust a panning speed of each camera;
a camera panning control unit for controlling the control data generation unit through the camera panning selection unit to generate data for controlling the panning of each camera and adjusting the panning speed of each camera;
a camera automatic panning selection unit comprised of a pan start point setting button, a pan return point setting button, an automatic pan start button and an automatic pan stop button to allow the user to set an automatic panning function of each camera;
a camera automatic panning control unit to control the control data generation unit through the camera automatic panning selection unit to generate data for automatic panning of each camera;
a camera automatic switchover setting unit comprised of a setting button for setting cameras to be automatically switched over or setting a switchover time, and a start button for activating automatic switchover to allow the user to set a automatic switchover function of each camera;
a camera automatic switchover control unit for controlling the control data generation unit through the camera automatic switchover setting unit to generate data for automatic switchover of each camera;
an adjustment/selection/setting data storage unit for storing data adjusted, selected and set by the camera focus adjustment unit, the camera zoom selection unit, the camera panning selection unit, the camera automatic panning selection unit and the camera automatic switchover setting unit;
a camera position memorizing unit for memorizing positions of all cameras installed in various locations; and
a video display unit for displaying video signals received from the computer video matrix switcher through a predetermined user interface.

4. A video matrix switcher, which is used in a CCTV system, for processing camera video signals, transmitting processed video signals to a video input terminal of a surveillance computer, and performing functions of driving and controlling cameras by a control program module installed in the surveillance computer (hereinafter, a computer), the video matrix switcher comprises:
a central processing unit (CPU);
a communication control unit for performing data exchange with the computer in which the control program module is installed to receive operation commands for the CPU and camera control data from the computer and to transmit performed results to the computer;
a video signal input unit for inputting camera video signals transmitted from a plurality of cameras through coaxial cables;
a video input signal switching unit for selecting inputted camera video signals under the control of the CPU; and
a composite signal output unit for converting video input signals into composite signals to be displayed on a monitor of the computer, and outputting the composite signals to the video input terminal of the computer.

5. A control program module for a computer-based remote surveillance CCTV system, which is means installed in a surveillance computer so as to allow the computer video matrix switcher constructed according to claim 4 to control cameras and to display camera videos to a user, the control program module comprises:
a control data generation unit for generating commands for controlling the CPU of the computer video matrix switcher and camera control data;
a camera focus adjustment unit for allowing the user to focus the camera;
a camera focus control unit for controlling the control data generation unit through the camera focus adjustment unit to generate data for controlling the focus of each camera;
a camera zoom selection unit for allowing the user to select a camera zoom function;
a camera zoom control unit for controlling the control data generation unit through the camera zoom selection unit to generate data for controlling the zoom of each camera;
a camera panning selection unit for allowing the user to select a panning function of each camera and adjust a panning speed of each camera;
a camera panning control unit for controlling the control data generation unit through the camera panning selection unit to generate data for controlling the panning of each camera and adjusting the panning speed of each camera;
a camera automatic panning selection unit for allowing the user to set an automatic panning function of each camera;
a camera automatic panning control unit to control the control data generation unit through the camera automatic panning selection unit to generate data for automatic panning of each camera;
a camera automatic switchover setting unit for allowing the user to set an automatic switchover function of each camera;
a camera automatic switchover control unit controls the control data generation unit through the camera automatic switchover setting unit to generate data for automatic switchover of each camera;
an adjustment/selection/setting data storage unit for storing data adjusted, selected and set by the camera focus adjustment unit, the camera zoom selection unit, the camera panning selection unit, the camera automatic panning selection unit and the camera automatic switchover setting unit;
a camera position memorizing unit for memorizing positions of all cameras installed in various locations; and
a video display unit to display video signals received from the computer video matrix switcher through a predetermined user interface.

6. A record media in which the control program module constructed according to claim 5 is recorded.
